(19) United States
(12) Patent Application Publication
(10) Pub. No.: US 2026/0312310 A1
(43) Pub. Date: Oct. 8, 2026

(54) SHORTING BLOCK COMPONENT FOR A CURRENT TRANSFORMER

(71) Applicant: Schweitzer Engineering Laboratories, Inc., Pullman, WA (US)

(72) Inventors: Gordon J. Tassell, Jr., Colfax, WA (US); Bradley W. Mohr, Lewiston, ID (US)

(73) Assignee: Schweitzer Engineering Laboratories, Inc., Pullman, WA (US)

(21) Appl. No.: 19/173,242

(22) Filed: Apr. 8, 2025

(51) Int. Cl. H01R 9/24; H01F 27/42; H01R 13/02; H01R 31/08

(52) U.S. Cl. CPC H01R 9/2491; H01F 27/427; H01R 13/02; H01R 31/08

(57) ABSTRACT

A shorting block includes a first shorting contact electrically configured to couple to a first terminal of a current transformer, a second shorting contact electrically configured to couple to a second terminal of the current transformer, and an activation plug configured to couple to the first shorting contact and the second shorting contact in an assembled configuration. The shorting block also includes a retainer that may couple to the first shorting contact and the second shorting contact in the assembled configuration, where the retainer is configured to substantially block movement of the first shorting contact away from the second shorting contact in the assembled configuration.

### FIELD OF DISCLOSURE

The present disclosure relates generally to the field of current transformers. More specifically, examples of the present disclosure relate to shorting blocks for current transformers.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Current transformers scale a supply current or voltage to a suitable value for a secondary power source or load, such as another transformer and/or a relay. For instance, current transformers may transform a high-voltage current to a level that may be suitable for operation of the secondary power source or load. In some cases, installation and/or maintenance procedures may involve connecting or disconnecting the current transformer from the secondary power source or load. Shorting blocks are utilized to disconnect the current transformer from the secondary power source or load while maintaining the high-voltage current of the current transformer within a closed-loop circuit. In other words, shorting blocks short circuit the current transformer while disconnecting the current transformer from the secondary power source or load. Unfortunately, existing shorting blocks may include components that undesirably deform or expand upon assembly, creating manufacturing burdens.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a shorting block, in accordance with an aspect of the present disclosure;

FIG. 2 is a perspective view of an embodiment of the shorting block, in accordance with an aspect of the present disclosure;

FIG. 3 is an exploded perspective view of an embodiment of the shorting block, in accordance with an aspect of the present disclosure;

FIG. 4 is a perspective view of an embodiment of a shorting contact of the shorting block, in accordance with an aspect of the present disclosure;

FIG. 5 is a plan view of an embodiment of the shorting contact of the shorting block, in accordance with an aspect of the present disclosure;

FIG. 6 is a plan view of a shorting assembly of the shorting block including an embodiment of a retainer, in accordance with an aspect of the present disclosure;

FIG. 7 is a plan view of an embodiment of the shorting assembly of the shorting block in an operating position, in accordance with an aspect of the present disclosure;

FIG. 8 is perspective view of an embodiment of the retainer coupled to the shorting assembly, in accordance with an aspect of the present disclosure;

FIG. 9 is perspective view of an embodiment of the retainer, in accordance with an aspect of the present disclosure;

FIG. 10 is cross-sectional view of an embodiment of the retainer and the shorting assembly within a housing, in accordance with an aspect of the present disclosure;

FIG. 11 is a perspective view of an embodiment of the shorting contact of the shorting block, in accordance with an aspect of the present disclosure; and

FIG. 12 is a plan view of an embodiment of the shorting contact of the shorting block, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As set forth above, current transformers may be utilized to regulate a voltage provided to a secondary power source or load (e.g., a relay, another transformer, an electronic instrument, and/or another power consuming device) in an electric power system. For instance, a current transformer may include a primary winding electrically coupled to a high-voltage current and a secondary winding electrically coupled to the secondary power source or load. The high-voltage current of the primary winding of the current transformer may be unsuitable for operation of the secondary power source or load. As such, the current transformer may decrease the voltage in order to provide a reduced-voltage current to the secondary power source or load that is suitable for operation of the secondary power source or load.

During normal operation, the current transformer is electrically coupled to the secondary power source or load via a shorting block to form a closed loop circuit between the current transformer and the secondary power source or load. The shorting block may be utilized to disconnect (e.g., electrically isolate) the current transformer from the secondary power source or load when undergoing maintenance procedures and/or installation of various components. For instance, the shorting block may generally short circuit the current transformer by forming a closed loop between terminals of the current transformer. The shorting block may include an operating position that electrically couples the current transformer to the secondary power source or load as well as a shorting position that disconnects the current transformer from the secondary power source or load while maintaining the current transformer in a closed loop circuit (e.g., electrically coupling the terminals of the current transformer to one another). The shorting block may include one or more shorting contacts configured to electrically couple the shorting block to the current transformer and/or the load. In an assembled configuration, two corresponding shorting contacts may be disposed within a housing of the shorting block, each configured to receive an activation contact electrically coupled to the load. Specifically, the two corresponding shorting blocks may first be placed within an activation plug to creating a shorting assembly. The shorting assembly may contain or couple to respective first sides of the corresponding shorting contacts, while second sides (e.g., exposed sides, free sides) may not be within the activation plug. Unfortunately, the structural constraints of the wall, and/or the structural components of the two corresponding shorting contacts may bias the second sides of the two corresponding shorting contacts in opposite directions. This expansion of the corresponding shorting contacts may create a burden when inserting the second sides of the corresponding shorting contacts into the housing of the shorting block, reducing manufacturing speeds.

Accordingly, the present disclosure is directed to a retainer of the shorting block configured to block movement of the shorting contacts while in the shorting assembly. Thus, the shorting block of the present disclosure may include a reduced manufacturing time, compared to other shorting blocks.

For instance, during assembly, first sides of the two corresponding shorting contacts may be placed within an activation plug, while second sides (e.g., exposed sides, free sides) may be exposed or not within the activation plug. To maintain the second sides of the corresponding shorting contacts in a substantially unbiased position (e.g., straight), a retainer may couple with both the first and second shorting contacts, blocking relative movement of the first and second shorting contacts. For example, the retainer may be positioned on the second sides of the shorting contacts in the shorting assembly. In this way, the corresponding shorting contacts and the activation plug may be inserted into additional components of the shorting block (e.g., the housing), without additional forces, such as a force by human application.

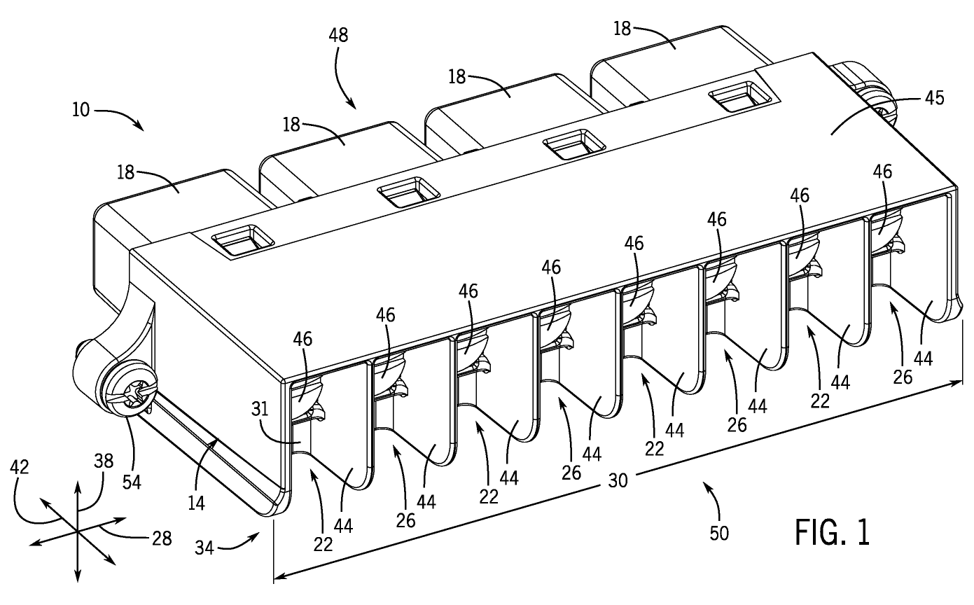

With the foregoing in mind, FIG. 1 is a perspective view of an embodiment of a shorting block 10, in accordance with one or more aspects of the present disclosure. As shown in the illustrated example of FIG. 1, the shorting block 10 includes a housing 14 that is configured to receive various components of the shorting block 10. The housing 14 may include openings configured to receive activation plugs 18 (e.g., noses). As described in detail herein, the activation plugs 18 may include apertures that receive activation contacts that ultimately transition the shorting block 10 between an operating position and a shorting position. In some examples, the activation plugs 18 may be formed integrally with the housing 14. In other examples, the activation plugs 18 may be a separate component from the housing 14 and coupled to the housing 14 via a weld, a fastener, a clamp, and/or another suitable securement feature. The activation plugs 18 may include a temperature resistant material such as nylon, nylon having a glass filler (e.g., 30% glass filler), or another suitable material.

The housing 14 has first compartments 22 and second compartments 26 that alternate along a length 30 of the housing 14, generally extending along an axis 28 (e.g., horizontal axis). The first compartments 22 may receive electrical connectors (e.g., wires, ring terminals, or other suitable terminals) of a first terminal of a current transformer. Similarly, the second compartments 26 may receive electrical connectors (e.g., wires, ring terminals, or other suitable terminals) of a second terminal of the current transformer. The first compartments 22 and/or the second compartments 26 may receive the electrical connectors from a bottom side 34 of the shorting block 10, relative to a direction of gravity and/or an axis 38 (e.g., vertical axis).

The first compartments 22 and the second compartments 26 may be at least partially defined by one or more walls 44 extending from the housing 14. For example, the walls 44 may extend from a top wall 45 of the housing 14 and extend from a back wall 31 to form or define a corner of the wall 44. The wall 44 may extend from the housing 14 any suitable length to protect one or more components of the shorting block 10 from the environment and/or to block inadvertent touch by a technician. In some embodiments, the shorting block 10 may not include the walls 44, and there may not be any compartments separating the components of the shorting block 10.

The electrical connectors of the first and second terminals of the current transformer may be coupled to the shorting block 10 via fasteners 46. In some embodiments, the fasteners 46 may be loosened and/or tightened using a tool (e.g., a screwdriver) to facilitate coupling the electrical connectors to the shorting block 10. In the illustrated embodiment, the fasteners 46 are coupled to one or more components of the shorting block 10 within the first compartments 22 and/or the second compartments 26. The fasteners 46 may be inserted into and removed from the first compartments 22 and/or the second compartments 26 from a back side 50 of the shorting block 10, in a direction generally parallel to the direction of the connecting orientation and/or the axis 42.

In some examples, the shorting block 10 may include one or more securement fasteners 54 configured to secure the housing 14 of the shorting block 10 to another component. For example, the shorting block 10 may be positioned in the electrical cabinet and secured to the electrical cabinet and/or the component within the electrical cabinet via the one or more securement fasteners 54. The securement fasteners 54 may block movement of the shorting block 10 with respect to the electrical cabinet, which may reduce inadvertent movement of components within the housing 14 and/or reduce inadvertent disconnection of electrical components of the shorting block 10.

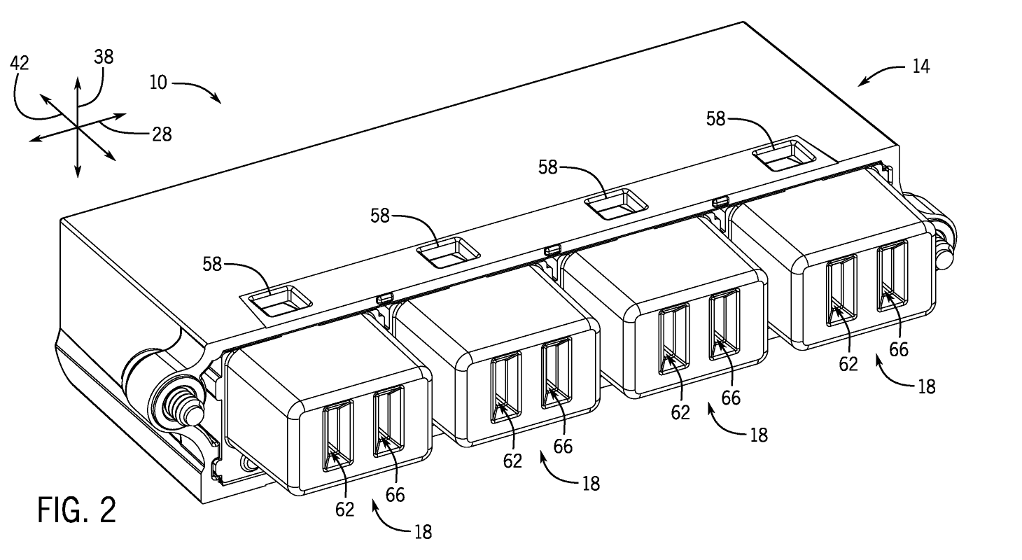

FIG. 2 is a perspective view of the shorting block 10 illustrating the activation plugs 18 secured to the housing 14 via an interface 58. For instance, the interface 58 may include openings within the housing 14 that receive respective protrusions of the activation plugs 18. The protrusions of the activation plugs 18 may be compressed upon insertion of the activation plugs 18 into the housing 14 and then move upward into the openings upon reaching the openings. The protrusions may then secure the activation plugs 18 to the housing 14 and substantially block movement (e.g., translational movement along the axis 42) of the activation plugs 18 with respect to the housing 14.

In the illustrated embodiment, the activation plugs 18 include first openings 62 and second openings 66 that may receive first activation contacts and second activation contacts, respectively. As discussed above, the first activation contacts may be electrically coupled to a first terminal of a secondary power source or load (e.g., a relay, another transformer, an electronic instrument, or another device that consumes power) and the second activation contacts may be electrically coupled to a second terminal of a secondary power source or load. Inserting the first and second activation contacts into the first and second openings 62, 66, respectively, causes the shorting block 10 to transition from a shorting position to the operating position (e.g., connecting orientation), which establishes an electrical connection between the current transformer and the secondary power source or load. The first and second openings 62, 66 of the activation plugs 18 may guide the first and second activation contacts toward shorting contacts that are disposed within the housing 14 and facilitate the transition between the shorting position and the operating position.

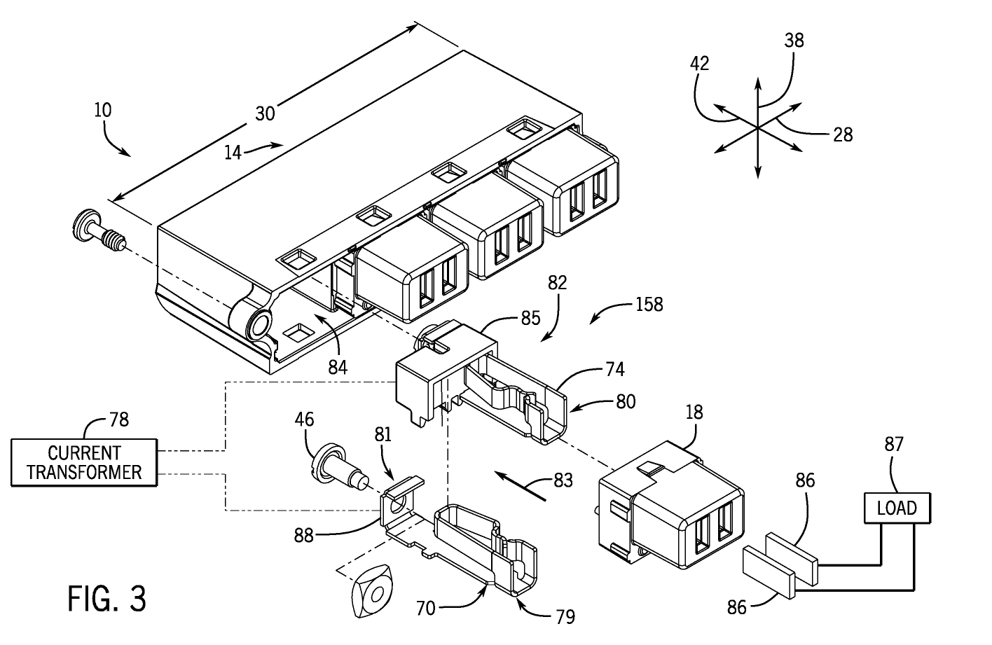

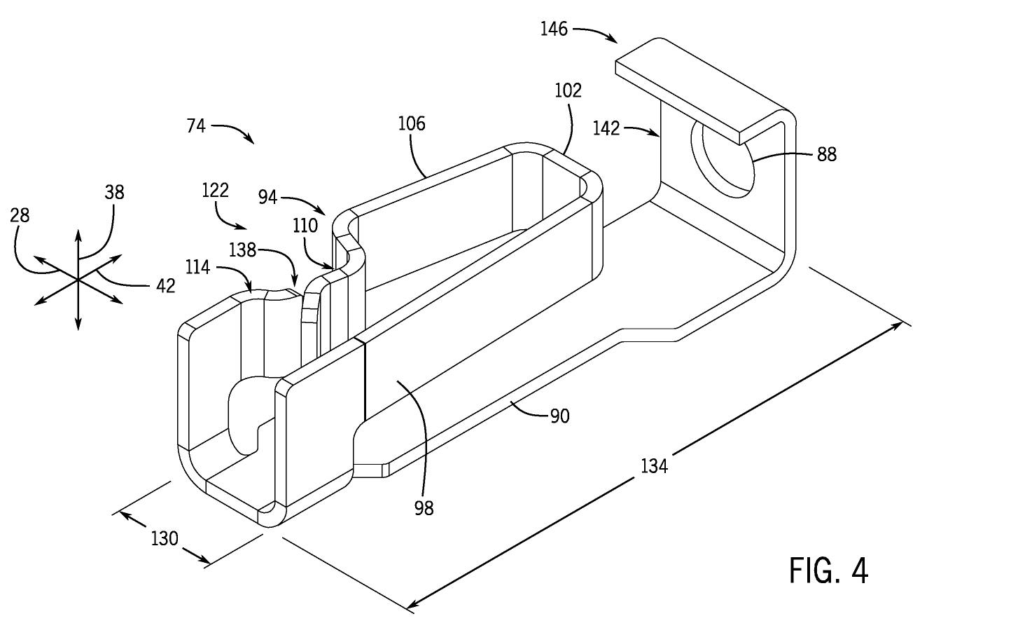

FIG. 3 is an exploded perspective view of an electric power system including an embodiment of the shorting block 10 illustrating first shorting contacts 70 and second shorting contacts 74 that are disposed within the housing 14. As shown in the illustrated example, the first and second shorting contacts 70, 74 alternate along the length 30 of the housing 14, thereby forming pairs of adjacent or corresponding first and second shorting contacts 70, 74. In some examples, the first shorting contacts 70 and the second shorting contacts 74 are mirror images of one another, or self-similar. The configuration of the first and second shorting contacts 70, 74 is discussed in further detail herein with reference to FIG. 4. The first and second shorting contacts 70, 74 are electrically coupled to a current transformer 78 and secured to the electrical connectors of the current transformer 78 by the fasteners 46. Thus, the first and second shorting contacts 70, 74 may include a conductive material, such as copper, copper alloy, aluminum, nickel, tin, another suitable metallic material, or any combination thereof to establish the electrical connection with the current transformer 78.

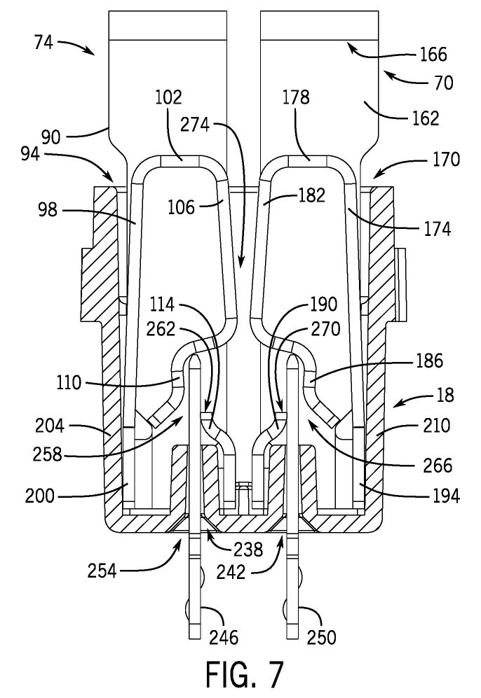

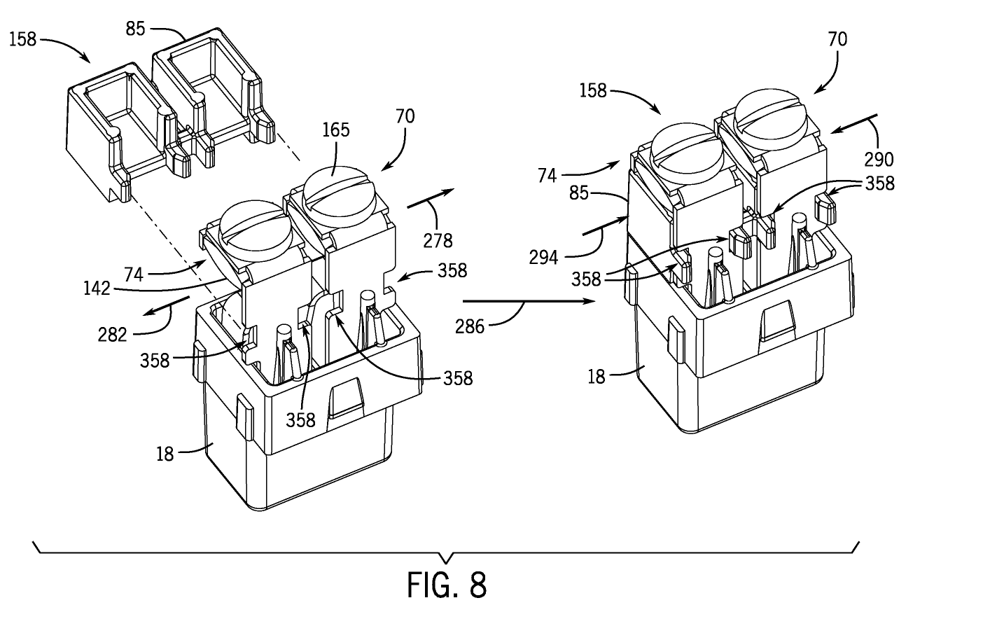

During manufacturing or assembly of the shorting block 10, the first and second shorting contacts 70, 72 may be secured to or within the activation plugs 18 to define a shorting assembly 158 (e.g., assembled configuration), prior to insertion into the housing 14 or a remaining portion of the shorting block 10. For example, the shorting assembly 158 may include a first side 79 of the first shorting contact 70 and a first side 80 of the second shorting block 74 disposed within the activation plug 18, while a second side 81 of the first shorting contact 70 and a second side 82 of the second shorting block 74 are exposed. In other words, the respective first sides 79, 80 of the first and second shorting contacts 70, 74 are engaged within the activation plug 18, while the respective second sides 81, 82 are protruding outward. Indeed, the shorting assembly 158, including the first and second shorting contacts 70, 74 and the activation plug 18, is illustrated in further detail with respect to FIGS. 7 and 8. Once assembled, the shorting assembly 158 may be inserted into a cavity 84 of the housing 14 in a direction 83 generally extending along the axis 42. As will be discussed in detail below, the structural constraints of the activation plug 18 and/or a biasing interaction between the first and second shorting contacts 70, 74 while in the shorting assembly 158 may bias the respective second sides 81, 82 of the first and second shorting contacts 70, 74 in opposite directions. As such, an overall size of the shorting assembly 158 near the second sides 81, 82 of the first and second shorting contacts 70, 74 may be greater than or expanded relative to the overall size of the shorting assembly 158 near the first sides 79, 80. The expansion of first and second shorting blocks 70, 74 may block the insertion of the assembled configuration into the cavity 84 of the housing 14.

To reduce or block expansion of the second sides 81, 82 of the first and second shorting contact 70, 74, a retainer 85 may be positioned in and/or on the first and second shorting contact 70, 74. For example, the first and second shorting contacts 70, 74 may be placed within the activation plug 18 at a first time to define the shorting assembly 158, and the retainer 85 may be subsequently positioned in and/or on the first and second shorting contacts 70, 74 to block movement or expansion of the second sides 81, 82 away from each other, maintaining the shorting assembly 158 in a substantially straight orientation. In this way, the retainer 85 may facilitate insertion of the shorting assembly 158 into the cavity 84 of the housing 14, expediting the manufacturing process. The retainer 85 may include a temperature resistant material such as nylon, nylon having a glass filler (e.g., 30% glass filler), or another suitable material.

The activation plugs 18 may receive activation contacts 86 that are electrically coupled to a load 87. As used herein, the load 87 may include any suitable device or component that receives current from the current transformer 78, such as another transformer, a relay, a power source, an electronic instrument, or any other suitable device. As will be appreciated, the electric power system may include the current transformer 78, the shorting block 10, and the load 87 electrically coupled together.

To secure electrical connection between the current transformer 78 and the shorting block 10, the electrical connectors of the current transformer 78 may be disposed between the fasteners 46 and the first and second shorting contacts 70, 74. The fasteners 46 may then be tightened toward the first and second shorting contacts 70, 74, such that the fasteners 46 pass through openings of the electrical connectors (e.g., o-rings, terminals) and openings 88 of the first and second shorting contacts 70, 74. The fasteners 46 thus secure the electrical connectors to the first and second shorting contacts 70, 74 and establish an electrical connection between the current transformer 78 and the first and second shorting contacts 70, 74.

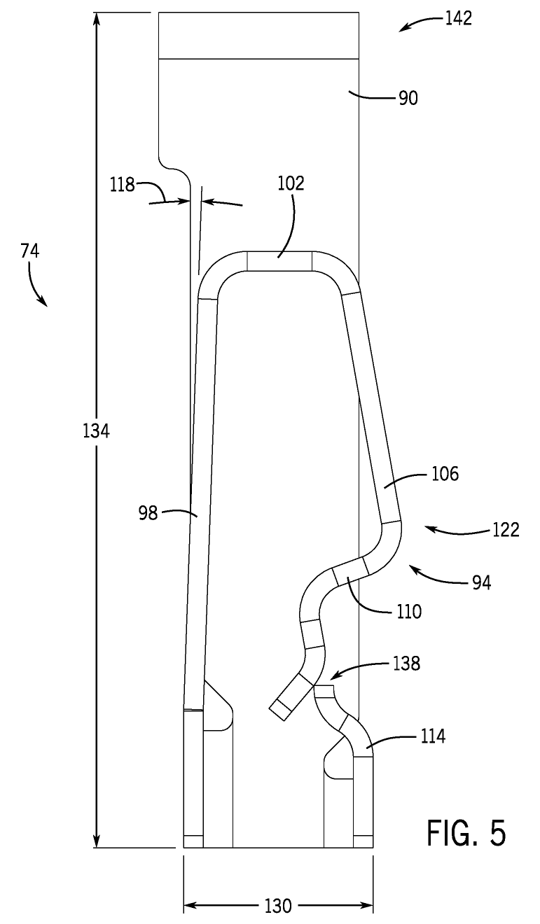

Referring to FIGS. 4 and 5, multiple views of an embodiment of the second shorting contact 74 are illustrated. As shown in the illustrated embodiments, the second shorting contact 74 includes a body 90 having the opening 88. The opening 88 may receive the fastener 46 to electrically couple the second shorting contact 74 to the electrical connector of the current transformer 78. Further, the body 90 is coupled to a shorting portion 94 of the second shorting contact 74 that is configured to enable the shorting block 10 to transition between the shorting position and the operating position.

The shorting portion 94 of the second shorting contact 74 includes an overlapping member 98, a bent portion 102, a biased portion 106, a first contact portion 110, and a second contact portion 114. As shown in the illustrated example, the overlapping member 98 is positioned at an angle 118 relative to the body 90 of the second shorting contact 74. The angle 118 of the overlapping member 98 may at least partially contribute to a bias of the biased portion 106, which enables the second shorting contact 74 to contact the first shorting contact 70 upon insertion into the housing 14 of the shorting block 10. For instance, the first shorting contact 70 is positioned on a side 122 of the second shorting contact 74 that is adjacent to the biased portion 106, and the angle 118 positions the biased portion 106 toward the side 122 to facilitate contact between the first shorting contact 70 and the second shorting contact 74. In some examples, the angle 118 may be between 0 degrees and 20 degrees, between 1 degree and 15 degrees, or between 3 degrees and 15 degrees.

The overlapping member 98 and the biased portion 106 are coupled to one another via the bent portion 102. While the bent portion 102 has a substantially linear cross-section in the illustrated embodiment of FIGS. 4 and 5, it should be recognized that the bent portion 102 may include any suitable shape or configuration, such a semi-circle. Additionally, the configurations of the overlapping member 98 and the biased portion 106 are not limited to the configurations illustrated in FIGS. 4 and 5. The bent portion 102 enables the overlapping member 98 and the biased portion 106 to substantially overlap with one another with respect to a width 130 of the second shorting contact 74 and/or the axis 28. In other words, the overlapping member 98 and the biased portion 106 are generally parallel to one another with respect to a length 134 of the body 90 and/or the axis 42. In some examples, the bent portion 102 enables the second shorting contact 74 to bend back on itself, such that the overlapping member 98 and the biased portion 106 form an angle of between 160 degrees and 200 degrees, or approximately (e.g., within 10% of, within 5% of, or within 1% of) 180 degrees, with one another. Further, by the second shorting contact 74 bending back on itself, the bent portion 102 allows the activation and deactivation to be performed via insertion of a male contact. Forming the overlap between the overlapping member 98 and the biased portion 106 with respect to the width 130 of the second shorting contact 74 enables the length 134 of the second shorting contact 74 to be reduced.

In some examples, the first contact portion 110 and the second contact portion 114 are in contact with one another at a contact point 138 before the second shorting contact 74 is disposed within the housing 12 of the shorting block 10. As such, contact between the first shorting contact 70 and the second shorting contact 74 may direct the first contact portion 110 away from the second contact portion 114 and form a gap between the first contact portion 110 and the second contact portion 114. In other examples, the gap between the first contact portion 110 and the second contact portion 114 may be formed prior to disposal of the second shorting contact 74 into the housing 14 of the shorting block 10. As such, the gap may increase in size due to contact between the first shorting contact 70 and the second shorting contact 74 upon assembly of the shorting block 10. The gap between the first contact portion 110 and the second contact portion 114 may facilitate insertion of the activation contact 86 between the first contact portion 110 and the second contact portion 114. In some embodiments, shorting of the shorting block 10 may be integrated into the first shorting contact 70 and the second shorting contact 74 such that shorting occurs prior to insertion and following removal of an activation contact between the first shorting contact 70 and the second shorting contact 74. In still further embodiments, the second contact portion 114 of the second shorting contact 74 may be eliminated, such that the activation contact 86 is configured to establish an electrical connection with only the first contact portion 110.

As discussed above, the embodiments of the present disclosure enable increased accessibility to one or more components of the shorting block 10. For example, the fastener 46 may be translate into and out of the opening 88 to couple the electrical connector (e.g., an o-ring of the electrical connector, terminal) of the current transformer 78 to the first shorting contact 70 and the second shorting contact 74. In other words, the fastener 56 may translate to engage and disengage the second shorting contact 74 in a direction generally along the length 134 of the second shorting contact 74 and/or the axis 42. To these end, the second shorting contact 74 may include an opening extension 142 coupled to the body 90, where the opening extension 142 may at least partially define the opening 88. In the illustrated embodiment, the opening extension 142 may extend substantially perpendicularly from the body 60, relative the length 134 and/or the axis 42. In this way, the opening 88 may be configured to receive the fastener 46 in the direction along the length 134 and/or the axis 42 (e.g., horizontally).

In an embodiment, the second shorting contact 74 includes a lip 146 that may further secure the second shorting contact 74 within the housing 14. For example, the lip 146 is configured to abut a protrusion, ledge, or other suitable feature within the housing 14 to block movement of the second shorting contact 74. Therefore, the lip 146 further secures the second shorting contact 74 within the housing 14, thereby reducing inadvertent movement of the second shorting contact 74 with respect to the housing 14 and/or inadvertent interruption of an electrical connection between the second shorting contact 74 and the current transformer 78. Additionally or alternatively, the lip 146 may facilitate engagement and/or securement of the fastener 46 with additional securing components, such as a nut. For example, the nut may abut the opening extension 142 on a first side (e.g., side facing the bent portion 126) and may receive the fastener 46 through the opening 88.

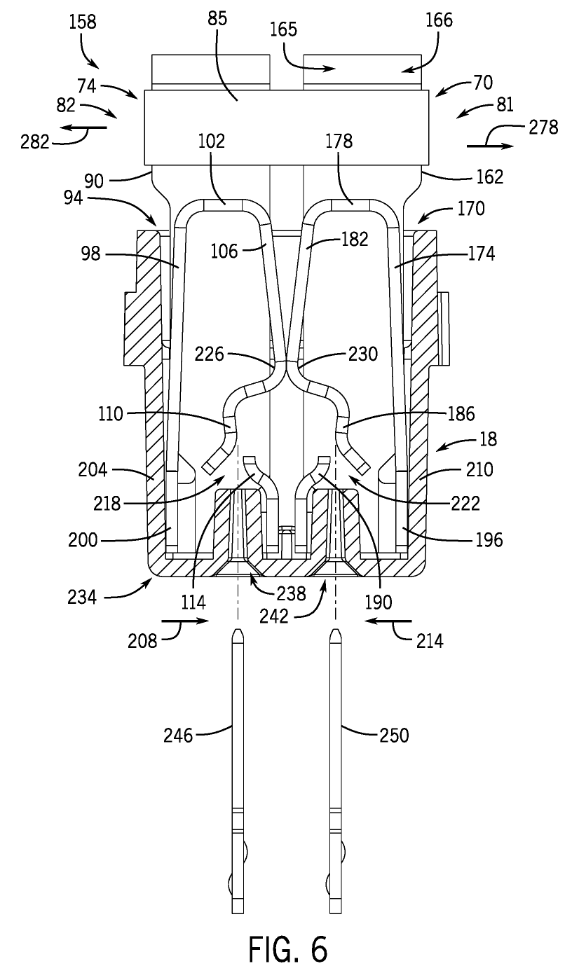

In some examples, disposing the first shorting contact 70 and the second shorting contact 74 into the housing 14 may cause the first and second shorting contacts 70, 74 to be in a shorting position. For instance, FIG. 6 is a plan view of an example of the shorting assembly 158 of the shorting block 10 having the first shorting contact 70 and the second shorting contact 74 in the activation plug 18. As shown in the illustrated embodiment of FIG. 7, the first shorting contact 70 is substantially a mirror-image of the second shorting contact 74 (e.g., the first shorting contact 70 and the second shorting contact 74 are self-similar). Thus, the first shorting contact 70 also includes a body 162 having an opening extension 165 defining an opening 166 configured to facilitate coupling the first shorting contact 70 to the current transformer 78 (e.g., an electrical connector of the current transformer 78). Further, the first shorting contact 70 includes a shorting portion 170 having an overlapping member 174, a bent portion 178, a biased portion 182, a first contact portion 186, and a second contact portion 190. Further, the shorting portion 170 of the first shorting contact 70 may be coupled to the body 162 via a base portion 196.

A base portion 200 of the second shorting contact 74 and the base portion 196 of the first shorting contact 70 may be disposed within the activation plug 18. In some examples, a first wall 204 of the activation plus 18 secures the base portion 200 and blocks movement of the body 90 of the second shorting contact 74. Further, the first wall 204 may apply an opposing force to the base portion 200 in a direction 208 that is opposite of a force applied to the shorting portion 94 by the first shorting contact 70. Similarly, the activation plug 18 may include a second wall 210 that is configured to secure the base portion 194 and block movement of the body 162 of the first shorting contact 70. Further, the second wall 210 may apply an opposing force to the base portion 196 that is in a direction 214 that is opposite of a force applied to the shorting portion 170 by the second shorting contact 74.

Accordingly, the opposing forces applied by the walls 204, 210 enable the shorting portions 94, 170 to contact one another and apply opposing forces to one another. The opposing forces applied to the shorting portions 94, 170 may be sufficient to drive movement of the first contact portions 110, 186 away from the second contact portions 114, 190, respectively. Accordingly, a first gap 218 may be formed between the first contact portion 110 and the second contact portion 114 of the second shorting contact 74 and a second gap 222 may be formed between the first contact portion 186 and the second contact portion 190 of the first shorting contact 70. In some examples, the first gap 218 and/or the second gap 222 may facilitate insertion of the activation contacts 86 between the first contact portions 110, 186, and the second contact portions 114, 190, respectively. Additionally, the opposing forces applied by the walls 204, 210 establish contact between the shorting portion 94 and the shorting portion 170 at a contact point 226 of the second shorting contact 74 and a contact point 230 of the first shorting contact 70. Therefore, an electrical connection is established between the first shorting contact 70 (e.g., coupled to a first terminal of the current transformer 78) and the second shorting contact 74 (e.g., coupled to a second terminal of the current transformer 78) to form a closed loop circuit between the first terminal of the current transformer 78 and the second terminal of the current transformer 78. The shorting block 10 is thus in a shorting position 234 when the first shorting contact 70 and the second shorting contact 74 are disposed within the activation plug 18 and the housing 14.

As shown in the illustrated embodiment of FIG. 6, the activation plug 18 includes a first opening 238 and a second opening 242 to enable access to the second shorting contact 74 and the first shorting contact 70, respectively, from outside of the activation plug 18. To transition the shorting block 10 to the operating position, a first activation contact 246 and a second activation contact 250 may be inserted into the first opening 238 and the second opening 242, respectively, to engage the second shorting contact 74 and the first shorting contact 70. The first activation contact 246 is electrically coupled to a first terminal or connection of the load 87 and the second activation contact 250 is electrically coupled to a second terminal or connection of the load 87. As such, the first activation contact 246 and the second activation contact 250 include a conductive material that establishes the electrical connection between the current transformer 78 and the load 87. In some examples, the first activation contact 246 and the second activation contact 250 include copper, copper alloy, aluminum, nickel, tin, another suitable metallic material, or any combination thereof. In other examples, the first activation contact 246 and the second activation contact 250 may include any suitable conductive material.

FIG. 7 is a plan view of the shorting assembly 158 in an operating position 254. As shown in the illustrated example of FIG. 7, the first activation contact 246 and the second activation contact 250 are disposed within the first opening 238 and the second opening 242, respectively. The first activation contact 246 engages the second shorting contact 74 and contacts the first contact portion 110 at a contact point 258 and contacts the second contact portion 114 at contact point 262. As such, an electrical connection is established between the first activation contact 246 and the second shorting contact 74 via the first contact portion 110 and the second contact portion 114. Similarly, the second activation contact 250 is electrically coupled to the first shorting contact 70 via a contact point 266 with the first contact portion 186 and a contact point 270 with the second contact portion 190.

Additionally, when the first activation contact 246 and the second activation contact 250 are engaged with the second shorting contact 74 and the first shorting contact 70, respectively, a gap 274 is formed between the second shorting contact 74 and the first shorting contact 70. As set forth above, the first activation contact 246 and the second activation contact 250 are both electrically coupled to the load 87, and thus, a closed loop circuit is formed between the current transformer 78 and the load 87 when the shorting block 10 is in the operating position 254.

Further still, the current transformer 78 is maintained within a closed loop circuit during insertion of the first activation contact 246 and the second activation contact 250. As a non-limiting example, in some cases, the first activation contact 246 may contact or otherwise engage the second shorting contact 74 before the second activation contact 250 contacts or engages the first shorting contact 70. As such, the first activation contact 246 may be electrically coupled to the first contact portion 110 and/or the second contact portion 114 before the second activation contact 250 contacts one or both of the first contact portion 186 and the second contact portion 190 of the first shorting contact 70. However, the current transformer 78 remains within a closed loop circuit because the contact point 226 of the second shorting contact 74 maintains contact with the contact point 230 of the first shorting contact 70. In other words, the first activation contact 246 may begin to urge the second shorting contact 74 away from the first shorting contact 70, but the biasing force of the shorting portion 170 of the first shorting contact 70 may continue to urge the first shorting contact 70 toward the second shorting contact 74 and maintain contact. Therefore, a closed loop is maintained between the first and second terminals of the current transformer 78 despite the second activation contact 250 not being in contact with the first shorting contact 70. The shorting block 10 of the present disclosure thus enables the current transformer 78 to remain within a closed loop circuit throughout the entire transition between the shorting position and the operating position, and vice versa. The shorting block 10 thus includes a make before break connection, which enables current flow to remain uninterrupted throughout transitions between the shorting position and the operating position.

Referring back to FIG. 6., the opposing forces applied by the walls 204, 210 enable the shorting portions 94, 170 to contact one another and apply opposing forces to one another. The opposing forces applied to the shorting portions 94, 170 may be sufficient to drive movement the second sides 81, 82 of the first and second shorting contacts 70, 74 in opposite direction. For example, the first and second biased portions 106, 182 may contact in the shorting assembly 158 (e.g., assembled configuration) to bias the second side 81 of the first shorting contact 70 in a direction 278 and the second side 82 of the second shorting contact 74 in a direction 282, generally opposite to the direction 278. To reduce or block movement or expansion of the respective second sides 81, 82 of the shorting contacts, 70, 74, the retainer 85 may be placed or disposed on the respective bodies 90, 162, to substantially block movement of the second sides 81, 82 in respective directions 278, 282.

With the foregoing in mind, to demonstrate various aspects of the retainer 85, FIG. 8 illustrates the retainer 85 transitioning into the shorting assembly 158 of the first and second shorting contacts 70, 74 coupled to the activation plug 18. The assembly of the retainer 85 to the shorting assembly 158 is shown over a period of time. The transition through time is depicted by arrow 286. As discussed above, once inserted into the activation plug 18, the counteracting forces applied by the first shorting contact 70 (e.g., biased portion 182) and the second shorting contact 72 (e.g., biased portion 182) may bias the second sides 81, 82 of the respective shorting contacts 70, 74 in opposite directions. The retainer 85 may be coupled to the first and second shorting contacts 70, 74 to counteract the forces applied by the first and second shorting contacts 70, 74. For example, once applied, the retainer 85 may apply a first force in a direction 290, to counteract the biasing force in the direction 278, and a second force in a direction 294, to counteract the biasing force in the direction 282. In this way, the shorting assembly 158 may include a substantially straight orientation, facilitating insertion of the shorting assembly 158 into the remaining housing 14 (e.g., cavity 84).

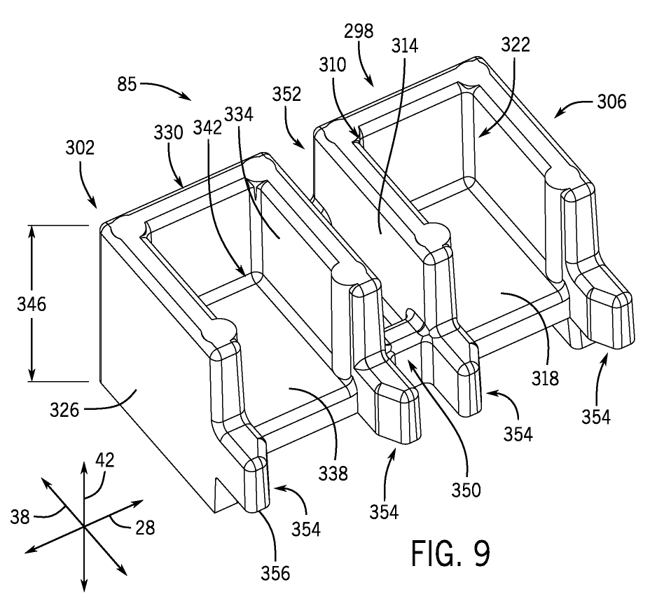

FIG. 9 illustrates an embodiment of the retainer 85, in accordance with one or more aspects of the present disclosure. To demonstrate one or more features and functions of the retainer 85, the below disclosure is with respect to both FIGS. 8 and 9. The retainer 85 of the present embodiment includes a first section 298, corresponding to the first shorting contact 70, and a second section 302, corresponding to the second shorting contact 74. The first section 298 includes an outer wall 306 (e.g., first wall), a top wall 310 (e.g., second wall), an inner wall 314 (e.g., a third wall), and a base wall 318 (e.g., a fourth wall), where the base wall 318 extends crosswise to the outer wall 306, the top wall 310, and/or the inner wall 314. The outer wall 306, the top wall 310, the inner wall 314, and the base wall 318 may define a cavity 322. In embodiments, the cavity 322 may receive or house a nut of the first shorting contact 70 and/or the fastener 46 in a coupled configuration. In some embodiments, the outer wall 306 may engage the fastener 46, coupled to the first shorting contact 70, to substantially block movement of the first shorting contact 70 away from the second shorting contact 74.

The second section 302 may be a mirror image or may include substantially the same structure as the first section 298. For example, the second section 302 includes an outer wall 326 (e.g., first wall), a top wall 330 (e.g., second wall), an inner wall 334 (e.g., a third wall), and a base wall 338 (e.g., a fourth wall), where the base wall 338 extends crosswise to the outer wall 326, the top wall 330, and/or the inner wall 334. The outer wall 326, the top wall 330, the inner wall 334, and the base wall 338 may define a cavity 342. In embodiments, the cavity 342 may receive or house a nut of the second shorting contact 74 and/or the fastener 46 in a coupled configuration. In some embodiments, the outer wall 326 may engage the fastener 46, coupled to the second shorting contact 74, to substantially block movement of the second shorting contact 74 away from the second shorting contact 70.

The first and second sections 298, 302 may be sized or shaped to facilitate coupling and securement to the first and second shorting contacts 70, 74. For example, as illustrated in FIG. 8, the retainer 85 may be disposed or coupled between the opening extensions 142, 165 and shorting portions 94, 170 (e.g., bent portions 102, 178) of the first and second shorting contacts 70, 74. As such, a length 346 of the retainer 85, generally extending along the axis 38, may be less than a distance between opening extensions 142, 165 and shorting portions 94, 170. In some embodiments, the length 346 of the retainer 85 may be substantially the same as the distance between opening extensions 142, 165 and shorting portions 94, 170, such that the retainer 85 abuts the opening extensions 142, 165 and/or shorting portions 94, 170 in the coupled configuration. In this way, the retainer 85 may provide increased support to the opening extensions 142, 165.

The first section 298 may be coupled to the second section 302 via a bridge 350 extending between the inner wall 314 of the first section 298 and the inner wall 334 of the second section 302. The bridge 350 may separate the first section 298 and the second section 302 to secure the first and second shorting contacts 70, 74 in a substantially straight orientation. In some embodiments, the bridge 350 may interact with a portion of the housing 14 in the coupled configuration to block movement of the first and second shorting contacts 70, 74. For example, the portion of the housing 14 may extend into a space 352 between the first section 298 and the second section 302 to block movement of the first and second shorting contacts 70, 74 in a direction along the axis 42, relative to the housing 14.

The retainer 85 may include one or more legs 354 (e.g., protrusions) configured to interact or engage with the first and second shorting contacts 70, 74. For example, the first and second shorting contacts 70, 72 may include one or more recesses 358 (e.g., cut outs, notches) in the respective body 90, 162 configured to receive corresponding legs 354 from the retainer 85 in the coupled configuration. The legs 354 of each respective section 298, 302 may be expanded or elastically deformed outward upon contact with a side of a corresponding recess 358 during coupling of the retainer 85, creating compressive force on the body 60, 162. In this way, the legs 354 may secure the retainer 85 to the first and second shorting blocks 70, 74 and may counteract biasing forces in the directions 282, 278 due to the contact between the first and second shorting blocks 70, 74.

In the illustrated embodiment, the retainer 85 includes four legs 354, two legs 354 corresponding to the first section 298 and two legs 354 corresponding to the second section 302. The legs 354 may extend from the respective outer walls 306, 326 and/or the respective inner walls 314, 334. In an embodiment, the retainer 85 may include less than four legs 354. For example, the retainer 85 may only include a first leg extending from the outer wall 306 of the first section 298 and a second leg extending from the outer wall 326 of the second section 302.

Further, the legs 354 may include any suitable shape and/or side to enable securement of the retainer 85 to the first and second shorting contacts 70, 74. In the illustrated embodiment, the legs 354 may include a tapered point 356 to facilitate engagement of the legs 354 and the recesses 358 during coupling and in the coupled configuration.

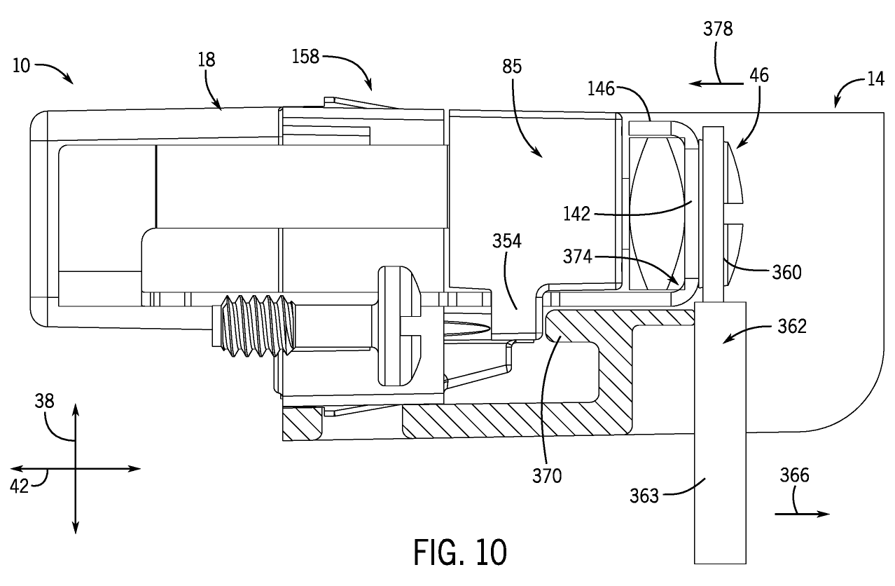

In the coupled configuration, the retainer 85 may reduce or block undesirable movement of the first and second shorting blocks 70, 74 relative to the housing 14. For example, while inserted in the recess 358, the legs 354 substantially block movement (e.g., translational movement along the axis 42) of the first and second shorting contacts 70, 74 with respect to the housing 14. To further demonstrate, FIG. 10 illustrates a cross-sectional view of the shorting block 10 including an embodiment of the retainer 85 while coupled to the first and second shorting contacts 70, 74, and within the housing 14. To facilitate discussion, the following disclosure is directed to second shorting contact 74, however, it will be appreciated the following disclosure may be with respect to both the first and second shorting contacts 70, 74.

As discussed above, the second shorting contact 74 may be coupled within the activation plug 18 before insertion into the housing 14 of the shorting block 10. Prior to insertion into the housing 14, the retainer 85 may be coupled to the first and second shorting blocks 70, 74 while in the shorting assembly 158 with the activation plug 18. The fastener 46 may secure a terminal piece 360 of an electrical connector 362 to the first and second shorting contacts 70, 74 and establish an electrical connection between the current transformer 78 and the first and second shorting contacts 70, 74. In some instances, a connector extension 363 of the electrical connector 362 may be pulled, either purposefully or inadvertently, in a direction 366 generally along the axis 42. In turn, the second shorting contact 74 may also be pulled or moved in the direction 366, relative to the housing 14. Advantageously, the retainer 85 may interact with the housing 14 to block translation of the second shorting block 74 in the direction 366 relative to the housing 14.

For example, while inserted into the housing 14 of the shorting block 10, the legs 354 may extend through body 90 (e.g., via the recesses 358) to contact a portion 370 of the housing 14. The contact between the legs 354 and the portion 370 of the housing 14 may substantially block movement of the second shorting contact 74 the direction 366 relative to the housing 14. In some instances, application of a force on the connector extension 363 of the electrical connector 362 in the direction 366 may impart an undesired bending moment (e.g., torque, rotational force) on the opening extension 142 to which the terminal piece 360 is secured. In particular, a force applied to the connector extension 363 in the direction 366 may bias the terminal piece 360 against the opening extension 142 and impart a corresponding force to the opening extension 142 in a direction 378 (e.g., generally opposite the direction 366). The corresponding force may cause the opening extension 142 to undesirably bend or deform (e.g., about a pivot point 374). Further, the deformation of the opening extension 142 may cause one or more additional parts of the second shorting contact 74 to become dislodged or misplaced within the shorting block. For example, the pivot point 374 may be lifted out of engagement with the housing 14 during deformation of the opening extension 142. As will be appreciated, the retainer 85 may abut the opening extension 142 (e.g., the lip 146) to substantially block movement of the opening extension 142 in the direction 378.

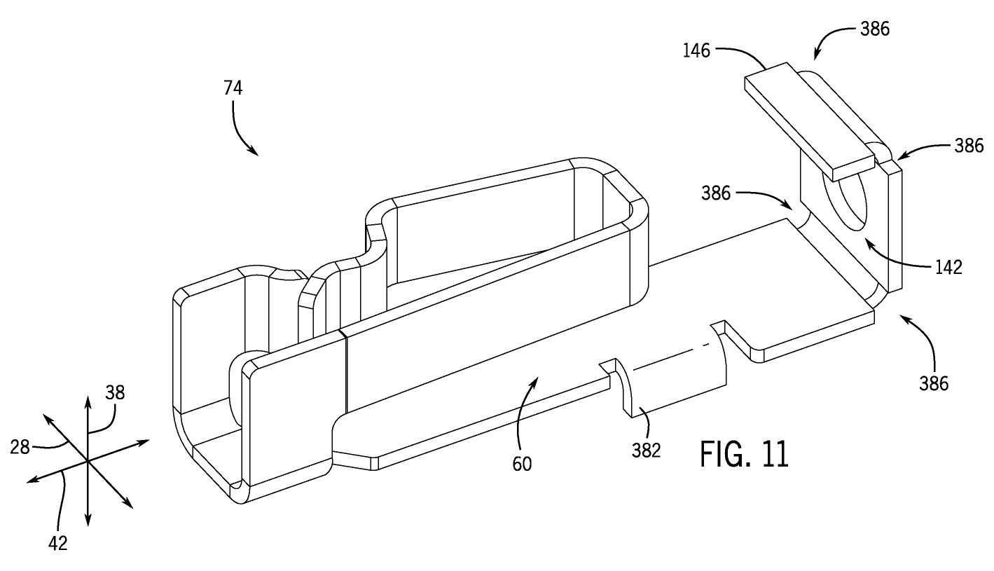

FIG. 11 illustrates yet another embodiment of the second shorting contact 74, in accordance with one or more aspects of this disclosure. In some embodiments, the second shorting contact 74 may include an engagement piece 382 extending from the body 60 in a downward direction (e.g., opposite to the extension direction of the opening extension 142), relative to the axis 38. While inserted into the housing 14, similar to the illustrated embodiment of FIG. 10, the engagement piece 382 of the second shorting contact 74 may engage with the housing 14 to substantially block movement (e.g., along axes 28, 42) of the second shorting contact 74, relative to the housing 14. Although one engagement piece 382 is illustrated, it will be appreciated any number or size of engagement pieces 382 may be included on the second shorting contact 74 (and/or the first shorting contact 70).

In an embodiment, the second shorting contact 74 includes one or more abutting portions 386 configured to engage with the housing 14 while coupled within the shorting block 10. The abutting portions 386 may be indentations or notches in the body 60, the opening extension 142, the lip 146, and/or the connecting portions between. For example, the abutting portions 386 may contact or abut one or more portions of the housing 14 to block movement of the second shorting contact 74 in directions along the axes 28, 38, 42.

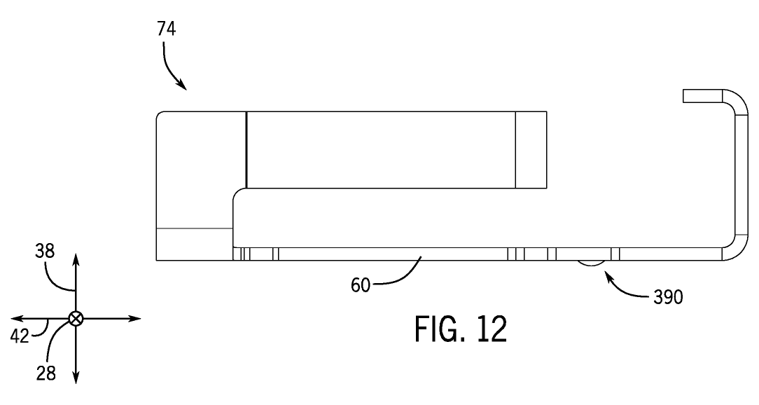

FIG. 12 illustrates yet another embodiment of the second shorting contact 74, in accordance with one or more aspects of this disclosure. In some embodiments, the second shorting contact 74 may include an engaging protrusion 390 (e.g., dimple) within the body 60, configured engage with the housing 14 to substantially block movement (e.g., along axes 28, 42) of the second shorting contact 74, relative to the housing 14. The engaging protrusions 390 may be machined (e.g., pressed) into the body 60 to extend in a downward direction (e.g., opposite to the extension direction of the opening extension 142), relative to the axis 38. Although one engaging protrusion 390 is illustrated, it will be appreciated any number or size of engaging protrusions 390 may be included on the second shorting contact 74 (and/or the first shorting contact 70).

As will be appreciated, any features or functions discussed herein as relating to one shorting contact (e.g., the first shorting contact 70, the second shorting contact 74) may also relate to another shorting contact (e.g., the first shorting contact 70, the second shorting contact 74) of the shorting block 10.

The embodiments set forth in the present disclosure may be susceptible to various modifications and alternative forms, specific embodiments have been shown by way of example in the drawings and have been described in detail herein. However, it may be understood that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). For any claims containing elements designated in any other manner, however, it is intended that such elements are not to be interpreted under 35 U.S.C. 112(f).

1. A shorting block, comprising:
a first shorting contact electrically configured to couple to a first terminal of a current transformer;
a second shorting contact electrically configured to couple to a second terminal of the current transformer;
an activation plug configured to couple to the first shorting contact and the second shorting contact in an assembled configuration; and
a retainer configured to couple to the first shorting contact and the second shorting contact in the assembled configuration, wherein the retainer is configured to substantially block movement of the first shorting contact away from the second shorting contact in the assembled configuration.

2. The shorting block of claim 1, wherein the first shorting contact comprises a first contact portion, and wherein the second shorting contact comprises a second contact portion, and wherein the first contact portion and the second contact portion are configured to electrically couple the first shorting contact and the second shorting contact in a shorting position of the shorting block.

3. The shorting block of claim 1, wherein the first shorting contact comprises a first shorting portion and a first opening extension, and wherein the second shorting contact comprises a second shorting portion and a second opening extension, wherein the retainer is configured to be coupled between the first shorting portion, the second shorting portion, the first opening extension, and the second opening extension.

4. The shorting block of claim 1, wherein the first shorting contact comprises a first side and a second side, and wherein the second shorting contact comprises a third side and a fourth side, wherein the first side and the third side are configured to be disposed within the activation plug in the assembled configuration, and wherein the second side and the fourth side are configured to be exposed in the assembled configuration, wherein the retainer is configured to be coupled to the second side and the fourth side.

5. The shorting block of claim 1, wherein the first shorting contact comprises a first body comprising one or more first recesses, and the second shorting contact comprises a second body comprises one or more second recesses.

6. The shorting block of claim 5, wherein the retainer comprises one or more legs, wherein the one or more legs are configured to engage with the one or more first recesses and the one or more second recesses to secure the retainer to the first shorting contact and the second shorting contact.

7. The shorting block of claim 1, wherein the shorting block includes a housing configured to receive the first shorting contact, the second shorting contact, and the activation plug in the assembled configuration.

8. The shorting block of claim 7, wherein the retainer comprises one or more legs configured to extend through the first shorting contact or the second shorting contact to engage with the housing.

9. The shorting block of claim 7, wherein the retainer is configured to substantially block movement of the first shorting contact and the second shorting contact while inserted into the housing.

10. An electric power system, comprising:
a current transformer comprising a primary winding and a secondary winding;
a load configured to electrically couple to the secondary winding of the current transformer; and
a shorting block configured to couple the current transformer to the load, wherein the shorting block comprises:
a first shorting contact electrically coupled to a first terminal of the current transformer;
a second shorting contact electrically coupled to a second terminal of the current transformer;
a first activation contact electrically coupled to the load;
a second activation contact electrically coupled to the load, wherein the first activation contact and the second activation contact are configured to be inserted into the first shorting contact and the second shorting contact, respectively, in an operating position of the shorting block; and
a retainer configured to be coupled to the first shorting contact and the second shorting contact, wherein the retainer is configured to substantially block movement of the first shorting contact and the second shorting contact relative to another component of the shorting block.

11. The electric power system of claim 10, wherein the shorting block comprises an activation plug configured to couple with the first shorting contact and the second shorting contact in an assembled configuration, wherein the retainer is configured to substantially block movement of the first shorting contact away from the second shorting contact in the assembled configuration.

12. The electric power system of claim 10, wherein first shorting contact comprises:
a body
an opening extension coupled to the body and extending in a first direction crosswise to the body;
an overlapping member coupled to the body;
a biased portion coupled to the overlapping member via a bent portion;
a first contact portion coupled to the biased portion, wherein the biased portion is configured to bias the first contact portion in a direction away from the overlapping member; and
a second contact portion coupled to the biased portion.

13. The electric power system of claim 12, wherein first shorting contact comprises an engagement piece extending from the body in a second direction opposite to the first direction, wherein the engagement piece is configured to engage a housing of the shorting block.

14. The electric power system of claim 12, wherein the retainer is configured to be coupled to the first shorting contact between the bent portion and the opening extension.

15. A retainer for a shorting block, comprising:
a first section corresponding to a first shorting contact, wherein the first shorting contact is electrically configured to couple to a first terminal of a current transformer;
a second section corresponding to a second shorting contact, wherein the second shorting contact is electrically configured to couple to a second terminal of the current transformer; and
a bridge configured to couple the first section and the second section,
wherein the retainer is configured to substantially block movement of the first shorting contact away from the second shorting contact.

16. The retainer of claim 15, wherein the first section comprises:
a first outer wall;
a first inner wall;
a first top wall; and
a first base wall, wherein the first outer wall, the first inner wall, the first top wall, and the first base wall define a first cavity, wherein the first cavity if configured to receive a first fastener.

17. The retainer of claim 16, wherein the second section comprises:
a second outer wall;
a second inner wall;
a second top wall; and
a second base wall, wherein the second outer wall, the second inner wall, the second top wall, and the second base wall define a second cavity, wherein the second cavity if configured to receive a second fastener.

18. The retainer of claim 15, comprising one or more legs extending from the first section and the second section, wherein the one or more legs are configured interact with the first shorting contact or the second shorting contact to secure the retainer to the first shorting contact and the second shorting contact.

19. The retainer of claim 15, wherein the first shorting contact comprises a first body and a first opening extension extending from the first body and the second shorting contact comprises a second body and a second opening extension extending from the second body, wherein the retainer is configured to substantially block movement of the first opening extension and the second opening extension relative to the first body or the second body.

20. The retainer of claim 15, wherein the bridge is configured to interact with a housing of the shorting block to substantially block movement of the first shorting contact and the second shorting contact relative to the housing.
